(19) United States
(12) Patent Application Publication
(10) Pub. No.: US 2024/0378753 A1
(43) Pub. Date: Nov. 14, 2024

(54) METHOD FOR CALIBRATING A ROAD MONITORING DEVICE, AND ROAD MONITORING SYSTEM

(71) Applicant: Continental Automotive Technologies GmbH, Hannover (DE)

(72) Inventor: Michael Goldhammer, Haibach (DE)

(73) Assignee: Continental Automotive Technologies GmbH, Hannover (DE)

(21) Appl. No.: 18/688,915

(22) PCT Filed: Jul. 26, 2022
(86) PCT No.: PCT/DE2022/200167

§ 371 Date: Mar. 4, 2024

(30) Foreign Application Priority Data
Sep. 3, 2021 (DE) 10 2021 209 698.0

(51) Int. Cl. G06T 7/80; G06T 5/30; G06T 7/70; G08G 1/01

(52) U.S. Cl. CPC G06T 7/80; G06T 5/30; G06T 7/70; G08G 1/01; G06T 2207/30236; G06T 2207/30242

(57) ABSTRACT

A method for calibrating a road monitoring device in which, for a predefined calibration period, the positions of detected objects in relation to the road monitoring device are recorded and an accumulated object residence map is formed therefrom. A world coordinate map of the lanes or lane centers for the monitoring region with their position in a predefined world coordinate system. A position and orientation are determined automatically with a predefined degree of correspondence by computer-based movement and/or rotation of the accumulated object residence map or an object residence map derived from it, in particular a filtered object residence map, and computer-based determination of a respective degree of correspondence to the world coordinate map. The actual position and actual orientation of the sensor are derived from this position, and the position of the objects is calibrated accordingly.

### CROSS-REFERENCE TO RELATED APPLICATIONS

The present application is a National Stage Application under 35 U.S.C. § 371 of International Patent Application No. PCT/DE2022/200167 filed on Jul. 26, 2022, and claims priority from German Patent Application No. 102021209698.0 filed in the German Patent and Trade Mark Office on Sep. 3, 2021.

### BACKGROUND

### 1. Field

Methods and apparatuses consistent with embodiments of the present application relate to a method for calibrating a road monitoring device and to a road monitoring system having at least one such road monitoring device.

### 2. Description of Related Art

Modern applications in the field of intelligent infrastructure use increasingly powerful sensor technology to detect road users. For a long time, induction loops embedded in the road surface were used almost exclusively for this purpose, but now sensors with a significantly larger capture range, such as cameras, radars and laser scanners, are used. Corresponding algorithms therefore allow automatic classification, localization and tracking of road users in real time. Future applications will make greater use of this extended object information to support driver assistance systems and autonomous driving, among other things.

The prerequisite for many of these applications is the localization of objects in a defined world coordinate system, in order to be able to resolve the individual lanes at intersections, for example, and to distinguish the objects accordingly. For the transformation from a sensor coordinate system to the world coordinate system, the position and orientation of the sensors are usually determined beforehand by means of calibration. This is usually done by placing reference objects that can be easily identified and located in the sensor data and whose position is also measured in the world coordinate system, e.g. by means of differential GPS. For this purpose, individual static positions can be measured in the field of view of the sensor or a larger number of positions can be generated by the time-stamped recording of a moving target mounted on a vehicle.

EP 2858055 B1 describes a corresponding method for calibrating a road monitoring system having a multiplicity of vehicle monitoring devices, wherein the multiplicity of vehicle monitoring devices are designed to measure a position of a vehicle driving through the monitoring region. Controlled by an ECU and synchronized with a global time signal, a calibration vehicle having a multiplicity of predefined calibration markers is provided for the purpose of calibrating the multiplicity of vehicle monitoring devices, wherein each vehicle monitoring device measures a position of its assigned calibration markers as the calibration vehicle drives through the monitoring region, wherein measurement is performed at a predetermined time.

In addition, a reference vehicle monitoring device which defines a reference coordinate system is required. The multiplicity of vehicle monitoring devices are calibrated in such a way that the position of the respective calibration markers in the reference coordinate system corresponds to an expected position in the reference coordinate system. The effort required for such calibration is therefore considerable and the use of reference vehicles with predefined calibration markers is unsuitable for repeated calibration during operation.

The methods therefore usually require a high-quality reference system for position determination. Even with technical availability, e.g. insufficient GPS reception in urban canyons is a problem. For static positioning of reference objects, it may be necessary to intervene in the ongoing flow of traffic, e.g. lanes must be temporarily closed. Measuring a relatively large number of static points can be time-consuming. In the case of a plurality of sensors with barely overlapping fields of view, the time required scales linearly and is therefore not suitable for repeated calibration in normal traffic.

If an object is used on a moving vehicle, the positions of the reference object as well as the sensor data themselves must be time-stamped to allow an assignment. Additional algorithms must be implemented in order to be able to detect the targets in the sensor data. Manual marking is also associated with additional effort.

Automatic calibration methods used for vehicle sensors usually use the vehicle's own motion, which is not the case with infrastructure sensors.

### SUMMARY

Aspects and objects of embodiments of the present application specify a calibration method which can be used more flexibly.

According to an aspect of an embodiment, there is provided a calibration method in which, for a predefined calibration period in normal traffic, the positions of detected objects in the monitoring region in relation to the road monitoring device are recorded and an accumulated object residence map is formed therefrom. According to testing on this side, the method is particularly suitable for radar sensors, but is also suitable for camera sensors and other environmental sensors with position recording, in particular and preferably with detection of the speed of the objects.

The accumulated object residence map should be understood as meaning the number of detected objects per position within the calibration period, i.e. how often objects are detected at a position, and this forms overall virtually a frequency distribution of objects within the monitoring region. Although this object residence map has a fixed reference to the sensor, i.e. the positions of the objects within the sensor coordinate system are known, but without calibration their position with regard to the world coordinate system is usually too imprecise, at least for traffic management. The accumulated object residence map is very much dependent on the traffic during the calibration period, but the calibration can be improved more and more by suitably choosing the timing and length of the calibration period or by repeating the calibration over several periods of time with known differences in traffic volume or direction of flow of the traffic. It should be emphasized that the accumulated object residence map does not currently require a trajectory analysis of the objects and only the respective positions of an object are accumulated.

In addition, however, there is a world coordinate map of the lanes or lane centers for the monitoring region with their position and orientation in a predefined world coordinate system, which is usually the case for navigation systems today.

The position and orientation of the road monitoring device in relation to the recorded objects is fixed and known, i.e. it forms in that sense a sensor coordinate system which must be calibrated to the world coordinate system, however.

A position and orientation of the object residence map in the world coordinate map are determined with a predefined, in particular the highest possible, or at least a sufficient, degree of correspondence by computer-based movement and/or rotation of the accumulated object residence map or an object residence map derived from it, in particular a filtered object residence map, and computer-based determination of a respective degree of correspondence to the world coordinate map.

From this position and orientation of the object residence map or derived, in particular filtered, object residence map, having the predefined degree of correspondence, it is now possible to derive the actual position and actual orientation of the road monitoring device by virtue of the fact that its position and orientation with respect to the objects and thus the object residence map are in turn fixed and known.

The position of the objects is now calibrated accordingly, i.e. the position measured in the sensor coordinate system is determined more precisely on the basis of the now known position of the road monitoring device in the world coordinate system.

The cross-correlation is preferably calculated as a method for determining the degree of correspondence.

Due to the amount of data and the complexity of the calculation, neither the accumulation of the object positions nor the movement and/or rotation of the accumulated object residence map, let alone the determination of a respective degree of correspondence to the world coordinate map, is still possible manually purely by the human mind, but rather an automated method is described here, which is automated and computer-based, wherein the necessary data, their storage and the computational processes can be carried out locally in the road monitoring device or a common computing unit of the road monitoring system in a corresponding processor for a plurality of road monitoring devices or even in a cloud-based manner via data communication in a cloud memory or corresponding server computer or the like.

Since the data of the accumulated object residence map are dependent on the traffic situation during the calibration period and may even contain individual measurement errors, i.e. incorrectly detected objects, the accumulated object residence map is subjected to two coordinated morphological operations, especially in an automated computer-based manner.

First of all, a dilation is carried out in order to extend a certain vagueness in the position determination by connecting to an object residence space. Subsequently, an erosion is carried out, wherein a respective degree of filtering during erosion is set to be greater by a predefined degree than the degree of filtering during dilation, so that positions with an extremely low frequency of objects are eliminated from consideration.

The degree of filtering or filter kernel is defined as that region in which values are combined during dilation or eliminated during erosion. Dilation and erosion are methods which are known per se from digital image processing and pattern recognition, but are very well suited to their use to calibrate the position and orientation of the sensor.

It should be emphasized that an object residence map filtered in this manner does not claim to be the most complete possible representation of the positions of all objects, but only has to be a sufficient database to orient this object residence map filtered in this manner on the basis of the world coordinate map. In this respect, it can even be extremely advantageous to be limited only to the essential positions that are relevant through repeated use and to eliminate atypical individual objects or their positions in order to be able to determine a degree of correspondence much more easily and still be able to determine the actual position and orientation more meaningfully.

Starting from a predefined starting position and starting orientation, a position and angular direction with a predefined, preferably large, degree of correspondence are now determined. In a preferred development, the rough information about the road monitoring device can be used as a starting position and starting orientation, or otherwise it is possible to start at a corner or in the middle of the intersection according to the world coordinate map.

According to an aspect of an embodiment, there is provided a calibration method in which, a first step is to initially move the object residence map or the object residence map derived from it, in particular the filtered object residence map, in a predefined first movement increment, preferably in both axes of the world coordinate map over that section of the world coordinate map which is conceivable for the monitoring region. A corresponding method is known per se as template matching from digital image processing and pattern recognition and is applied here to the calibration between the object residence map and the world coordinate map.

The object residence map or the object residence map derived from it, in particular the filtered object residence map, is then rotated in a predefined first rotational increment and the moving is repeated, that is to say moving and rotating alternate until all positions in the predefined section of the world coordinate map have been tested with the first movement increment and rotational increment and a position and orientation with the greatest degree of correspondence in this pass has been found.

In accordance with a preferred development, it is provided that, after the first step, the object residence map or the object residence map derived from it, in particular the filtered object residence map, is moved at least in a further step around the position and orientation determined in the first step in a predefined second increment that is finer than the first, and then, if necessary, is rotated again, again in a predefined second rotational increment that is finer than the first, and a check is carried out in each case in order to determine whether an even higher degree of correspondence can be achieved. If necessary, this refining can also be repeated again with a third, even finer increment and/or rotational increment.

However, according to a preferred configuration, at least a rough target position and/or target orientation in relation to the world coordinate map is/are predefined to the road monitoring device and the calibration is started from this target position and/or target orientation.

One development also provides for the detected objects to be evaluated with regard to object type classes and/or their position change speed, and for only those objects which correspond to predefined object type classes and/or a predefined range of the position change speed to be included in the accumulated object residence map, i.e., for example, stationary objects in particular are completely eliminated.

Since the accumulation of the object map depends on the current traffic in the monitoring region, the calibration period is preferably adjusted to the number of detected objects, in particular extended, in a variable manner over time, if a predefined number of objects could not be assigned to the accumulated object residence map within the first predefined target calibration period and/or the achievable degree of correspondence remains below a minimum value.

As already mentioned at the outset, the calibration is carried out according to at least one embodiment during normal traffic in the monitoring region and is repeated cyclically in particular.

Apart from the world coordinate map, no further references are required, in particular no detection and measurement of additional reference points, in particular no static, measured reference points in the monitoring region or reference points on test vehicles with a defined driving behavior, but rather the method is suitable for using the objects occurring in normal traffic and can therefore also be repeated cyclically without any problems, e.g. can be operated at different times of the day with a different traffic behavior or in response to specific events or sensor signals, or even permanently in parallel with the actual traffic monitoring, provided that the necessary computational effort is available.

The method is preferably embedded in a road monitoring system having at least one, preferably a multiplicity of, such road monitoring device(s) for covering the different viewing angles of an intersection region, wherein the monitoring regions of the respective road monitoring devices overlap at least partially according to at least one development. A computing unit for evaluating the signals from the road monitoring devices is provided and a world coordinate map of the lanes or lane centers for the monitoring region with their position in a predefined world coordinate system is stored locally in a memory of the computing unit or is reachable in a cloud memory via data communication.

The automated, computer-based processing of the object data and/or filtering of the accumulated object residence map, the moving and/or rotation of the accumulated object residence map or the object residence map derived from it and determination of the respective degrees of correspondence take place by means of the computing unit locally or a server computer reachable via data communication.

### BRIEF DESCRIPTION OF THE DRAWINGS

The disclosure is explained in more detail below on the basis of exemplary embodiments with reference to the Figures, in which:

FIG. 1 is a diagram illustrating an intersection situation with at least one road monitoring device and its monitoring region;

FIG. 2 is a diagram illustrating a world coordinate map of the lane centers for the intersection according to FIG. 1 with a position in the world coordinate system;

FIG. 3 is a diagram illustrating an accumulated object residence map;

FIG. 3A is an exploded diagram illustrating the object residence map according to FIG. 3;

FIG. 4 is a diagram illustrating a filtered object residence map;

FIG. 4A is an exploded diagram illustrating the filtered object residence map; and

FIG. 5 is a diagram illustrating a filtered object residence map oriented on the world coordinate map.

### DETAILED DESCRIPTION

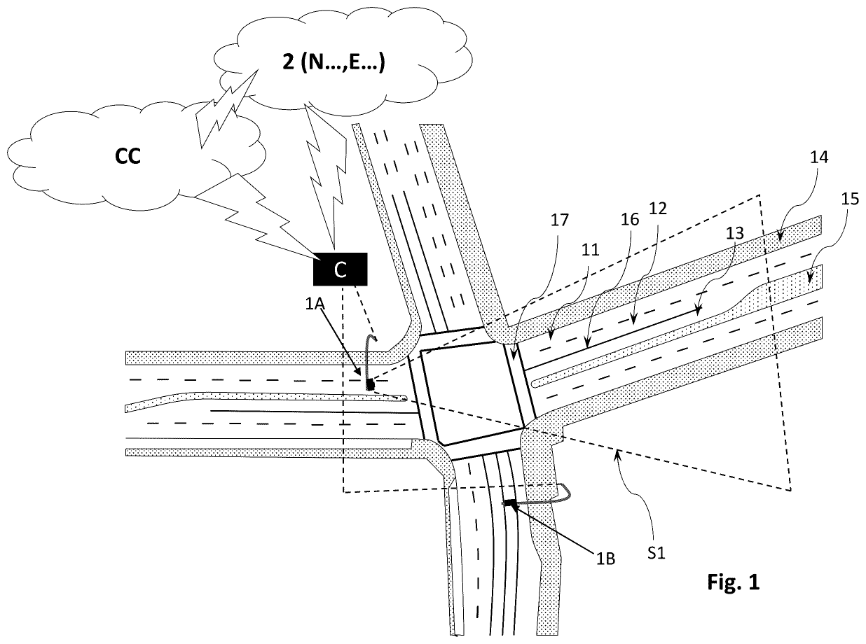

FIG. 1 shows, in a stylized manner, an intersection situation with at least one first road monitoring device 1A and its monitoring region S1, which records at least a large part of the intersection as well as one of the roads leading to the intersection with its lanes 11, 12 and 13 and edge regions 14 and 15. The lane lines 16 shown here in sketched form are for understanding, but are not necessarily visible to the road monitoring device 1A which is in the form of a radar sensor. In particular, in addition to automobile traffic, the road monitoring devices also record pedestrians, cyclists and other moving objects in the monitoring region, and therefore the pedestrian crossing 17 is also shown here. However, for the sake of simplifying this exemplary embodiment, this traffic route and pedestrians are not taken into account any further here.

FIG. 1 also shows a further road monitoring device 1B which records another road that also leads to the intersection and an overlapping region of the intersection. Further additional road monitoring devices (not shown) may be provided, for example, depending on the number of roads, the complexity of the intersection and the size of the monitoring regions of the road monitoring devices, as well as any obstacles in their viewing angles. The road monitoring devices, i.e. at least shown here 1A and 1B, are combined to form a road monitoring system and are connected to a computing unit C which evaluates the signals from the road monitoring devices. In addition, a cloud memory available in particular in a cloud-based manner and via wireless data communication shown here in sketched form is available for a world coordinate map 2 (N . . . ,E . . . ) to be explained in more detail, and a server computer CC is available for the centralized performance of the comparatively computationally intensive process steps of the method, which are explained in more detail below.

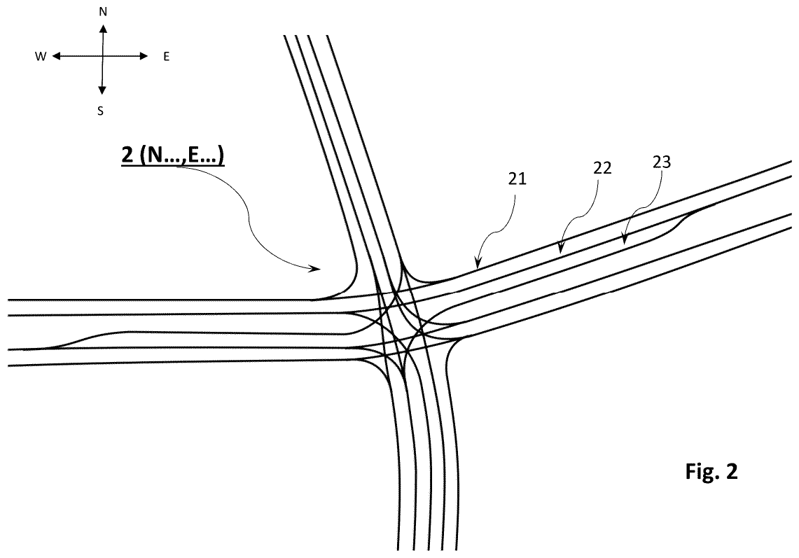

FIG. 2 now shows the world coordinate map 2 (N . . . ,E . . . ) of the lane centers for the intersection region shown in FIG. 1, wherein half of the lateral distance between the lane markings delimiting the lane or, if there is no lane, correspondingly analogously determined lines, is determined as the lane center, i.e. runs in the middle between the lanes and concomitantly records in particular all traffic-compliant passages, especially through the intersection region, i.e. all conceivable turning processes. As is intended to be illustrated in sketched form through the coordinate system N,S,W,E and the N . . . ,E . . . values, for this world coordinate map 2 (N . . . ,E . . . ) its position in the world coordinate system, especially GPS or the other positioning systems now available, is available as precisely as possible and is also measured precisely with regard to the orientation in the cardinal directions.

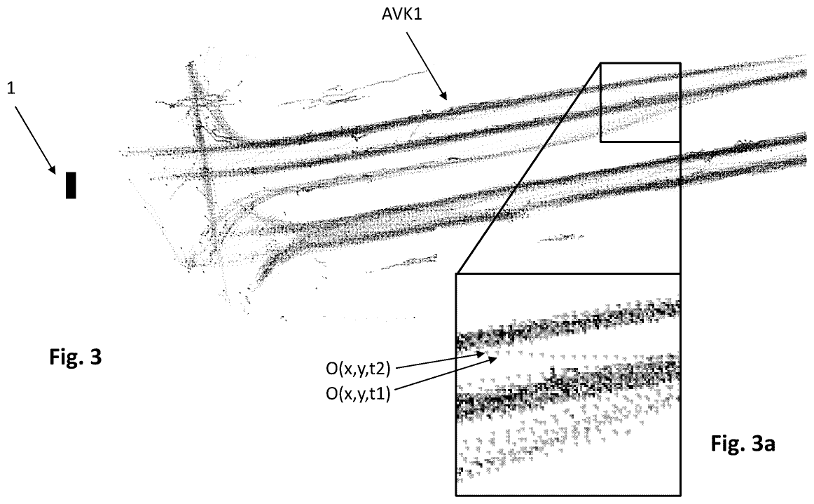

FIG. 3 now shows an accumulated object residence map AVK1, as was recorded over a defined calibration period during a real driving mode with normal vehicles and other road users in the monitoring region. This accumulated object residence map AVK1 is known exclusively in relation to the road monitoring device, i.e. in the sense of a sensor coordinate system, but is not orientated to the world coordinate system, even though an approximately identical orientation was chosen here in the application for reasons of limited representability and easier transferability.

At each position where the road monitoring device, in this case a radar sensor, detects an object, a value for the number of object residences is increased. This value is shown here in sketched form as a gray-scale value and becomes increasingly darker, i.e. blacker, with an increasing number and frequency of object residences at the respective position. In this case, this is done on a white sheet of paper exclusively on account of the formal requirements for the application, but, in the practical configuration, for visualization, the background is usually chosen to be black and the positions are shown in white with increasing object residence. As can be seen in particular from the enlarged section according to FIG. 3A, the individual detected positions of an object O(x,y,t1), O(x,y,t2) are shown as individual points and no elaborate trajectory is deliberately determined from the sequence.

However, it should be clarified once again that the object residence map shown here in FIGS. 3 and 3A only serves as a visualization for the application, but can be implemented on the computer side in the memory purely as values of the frequency of the object residence at the respective positions.

In the present exemplary embodiment, the detected objects were also evaluated with regard to object type classes and their position change speed, and only those objects which correspond to predefined object type classes and a predefined range of the position change speed are included in the accumulated object residence map, i.e. stationary objects are usually completely hidden, here for simplicity also pedestrians or other extremely slow objects, wherein, in addition to the pure position change speed of the objects, their object type classes, for example due to their shape or radar echo signature, can also be evaluated. If neither the determination of object type classes nor the position change speed of the objects or only one of the two variables is available, the accumulation can be restricted only on the basis of the available data or otherwise by the properties of the sensor, e.g. reflection maxima in radar sensors themselves.

However, it should be clarified that, for traffic detection per se, a vehicle at an intersection is also expediently detected for the purpose of controlling the traffic flow, but the accumulated object residence map formed here is only intended to be used to calibrate the position of the sensor in interaction with the world coordinate map and therefore a consideration purely of flowing automobile traffic is sufficient for this, especially since pedestrians adhere to defined lane lines much less and thus their positions are less suitable for determining the most exact orientation of the sensor.

It should be emphasized once again that the calibration is carried out in normal traffic in the monitoring region, i.e. can be carried out only on the basis of the objects occurring in normal traffic and, apart from the world coordinate map, no further references are required, in particular no detection and measurement of additional reference points, in particular no static, measured reference points in the monitoring region or reference points on test vehicles with a defined driving behavior. In this way, the calibration can be repeated cyclically, for example even at other times of the day with different traffic patterns.

The calibration period can be adjusted to the number of detected objects, in particular extended for example, in a variable manner over time, if a predefined number of objects could not be assigned to the accumulated object residence map within the first predefined target calibration period or the achievable degree of correspondence remains below a minimum value.

After the road monitoring device has been installed, sensor data are therefore initially recorded until a certain number of objects have been detected. The positions of the objects are accumulated into a grid over the measurement time. If speed information is available, only moving objects are taken into account in order to improve the differentiation from static background objects.

The resulting accumulated object residence map AVK1 is now filtered according to this exemplary embodiment successively with the morphological operations of dilation and erosion that are known per se, in order to highlight the maxima of the active traffic flow more clearly.

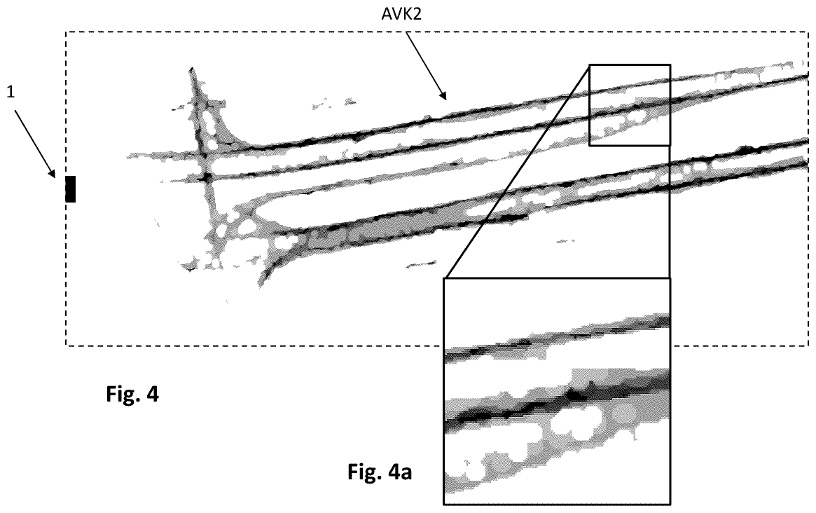

The dilation initially connects adjacent points, but points that are too small or infrequent are then eliminated by the following erosion. The degree of filtering, i.e. the filter kernel, of the erosion is thus chosen to be slightly larger than that of dilation in order to eliminate undesirable individual points in the filtered object residence map AVK2, as shown in FIG. 4 and a section enlarged in FIG. 4A. Compared with the unfiltered map from FIG. 3, the object positions and their frequency are condensed by the filtering and thus the lanes are already even easier to read, in which case the edge regions shown here now in lighter gray are not as problematic for the subsequent positioning as might be assumed, since the correspondence with the lanes is determined purely numerically on the basis of, for example, the cross-correlation, and a relatively good dependence on the correct orientation still results overall even with such a blurred image.

In a first step, a first movement increment and rotational increment are now used to search for that position and angular orientation which have at least a predefined, preferably largest, degree of correspondence.

In a first step, the filtered object residence map AVK2 is moved over a predefined section of the world coordinate map in a predefined first movement increment and that position with the greatest degree of correspondence for this angular orientation is determined. So-called template matching, which is known from digital image processing and is available as an algorithm in software, is particularly suitable for the moving. The filtered object residence map AVK2 is then rotated with a predefined first, larger rotational increment and the moving is repeated.

As a degree of correspondence, the cross-correlation of the points from the two maps, i.e. the world coordinate map and the respective rotated and/or moved object residence map AVK2, is preferably achieved.

After the first step, preferably at least in a second step, the filtered object residence map AVK2 is rotated again around the rough position and orientation determined in the first step in a predefined second rotational increment that is finer than the first, and a check is carried out in order to determine whether an even higher degree of correspondence can be achieved. In the first step, the AVK2 is thus rotated in defined angular increments and roughly compared with the map of the lane centers using 2D template matching.

Around that angular orientation and that position which provide the maximum correspondence in the first step, a further search is carried out in smaller angular increments and/or movement increments in order to locate the optimum more precisely.

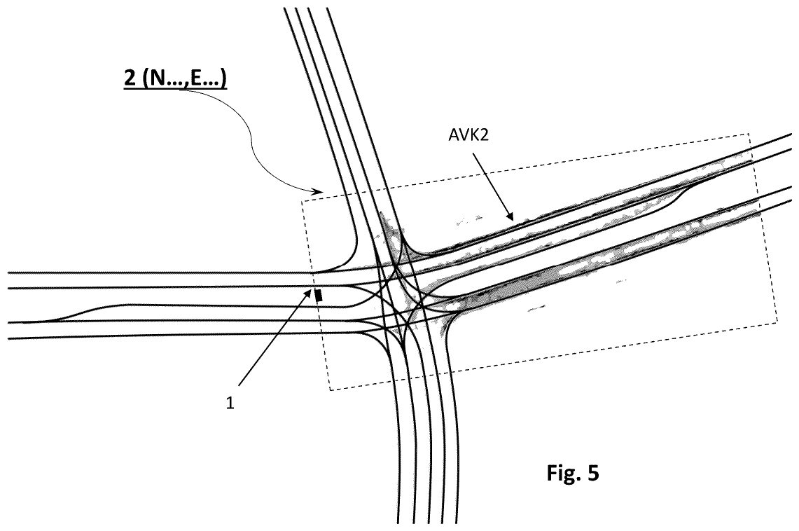

FIG. 5 shows a filtered object residence map AVK2 oriented in this way on the world coordinate map 2 (N . . . ,E . . . ) of the lanes or lane centers by moving and rotating.

The position and azimuth orientation of sensor 1 in the map, and thus in real world coordinates, can be determined from the final location of the optimum, i.e. the actual position and orientation of the sensor can be derived from this found position and the position of the objects can be accordingly determined more precisely.

The calibration can therefore be carried out during ongoing road traffic, cyclically repeated or, if the appropriate computing capacity is available, theoretically run permanently. No additional reference objects or highly accurately measured reference positions are required. A misalignment of the sensors can be detected and reported or corrected during operation by comparing a recalibration with the result of the original calibration, i.e. an automatic recalibration can be performed, especially if minor changes are detected.

The required data can be recorded in parallel for a plurality of sensors and accordingly the complex calculations can also be carried out externally.

1. A method of calibrating a road monitoring device, the method comprising:
for a predefined calibration period, recording positions of objects detected by the road monitoring device in relation to the road monitoring device;
generating an accumulated object residence map based on the positions of the objects in relation to the road monitoring device;
determining a position and orientation of the objects based on the accumulated object residence map and a world coordinate map of lanes or lane centers of the objects in a world coordinate system; and
determining a position and orientation of the road monitoring device from the position the orientation of the objects.

2. The method as claimed in claim 1, further comprising:
performing dilation and subsequently erosion on the accumulated object resistance map, wherein a degree of filtering during erosion is set to be greater by a predefined degree than a degree of filtering during; and
orienting the object residence map on the basis of the world coordinate map.

3. The method as claimed in claim 1, further comprising adjusting the accumulated object residence map from a predefined starting position and starting orientation in a predefined first movement increment and rotated in the respective position in a predefined first rotational increment.

4. The method as claimed in claim 3, further comprising adjusting the accumulated object residence map around the position and angular orientation determined in a predefined second movement increment that is finer than the first movement increment and/or rotated in a predefined second rotational increment that is finer than the first rotational increment.

5. (canceled)

6. The method as claimed in claim 1, further comprising:
defining a rough target position and/or target orientation in relation to the world coordinate map to the road monitoring device; and
calibrating the road monitoring device starting from the rough target position and/or target orientation.

7. The method as claimed in claim 1, further comprising evaluating the objects with regard to object type classes and/or position change speed; and
including only those objects which correspond to predefined object type classes and/or the predefined range of the position change speed in the accumulated object residence map.

8. The method as claimed in claim 1, further comprising adjusting the calibration period to a quantity of detected objects in a variable manner over time, if a predefined quantity of objects could not be assigned to the accumulated object residence map.

9-10. (canceled)
